(19) United States
(12) Patent Application Publication
(10) Pub. No.: US 2025/0225778 A1
(43) Pub. Date: Jul. 10, 2025

(54) AUTOMATED VERIFICATION OF DOCUMENTS RELATED TO ACCOUNTS WITHIN A SERVICE PROVIDER NETWORK

(71) Applicant: Amazon Technologies, Inc., Seattle, WA (US)

(72) Inventors: Chang Liu, Everett, WA (US); Vishal Jain, Bothell, WA (US); Baiyu Zhao, Beijing (CN); Yu Yang, Beijing (CN); Lin Lin, Beijing (CN); Chong Tian, Beijing (CN); Nan Wang, Beijing (CN)

(21) Appl. No.: 18/007,692

(22) PCT Filed: Sep. 29, 2022
(86) PCT No.: PCT/CN2022/122503

§ 371 Date: Dec. 1, 2022

(51) Int. Cl. G06V 10/82; G06T 5/73; G06V 10/40; G06V 30/19

(52) U.S. Cl. CPC G06V 10/82; G06T 5/73; G06V 10/40; G06V 30/19093; G06V 2201/09

(57) ABSTRACT

This disclosure describes a verification service within a service provider network for automatically verifying and validating documents. A user may upload a document image to the verification service. A pre-processing service may pre-process the document image. The pre-processed document image may then be forwarded to a first machine learning ML model for similarity evaluation. Once the first ML model has completed its evaluation of the document image, the first ML model may forward the document image to a second ML model for symbol recognition, which may then forward the business license to an optical recognition (OCR) service for OCR validation. If the document image is validated, e.g., is an image of a purported document type, as will be discussed further herein, the publishing service may pre-populate, e.g., publish, information from the document image to an account template.

### BACKGROUND

Service providers offer cloud-based services via service provider networks to fulfill user's computing-service needs without the users having to invest in and maintain computing infrastructure required to implement the services. These service providers are generally in the form of on-demand computing platforms that may provide network-based computing resources and functionality to implement various types of cloud-based services, such as, for example, scalable-storage services, computer-processing services, and so forth. In some examples, developers may utilize services offered by the service provider to run the systems and/or applications using virtual services (or “instances”) provisioned on various configurations of hardware-based resources of a cloud-based service.

Currently, in certain regions, to open a business account with certain businesses, e.g., service provider networks, certain requirements need to be met. For example, the user needs to be a “business customer.” Thus, a business needs to collect necessary company information such as, for example, company name, address, etc. and a photocopy of a valid government issued business registration during sign up to be a business customer. A business license generally serves as a valid business registration proof.

While a business license may be validated manually to make sure the information matches the information entered by a user during their signup form and that it matches the registration in a government database. Typically, information is usually manually validated based on various features included on the business license. However, verifying each business license image manually is an extremely labor-intensive process that includes long processing wait times for users.

Additionally, during the signup process for the business account, users are required to enter information in multiple fields out of which many fields are open text fields that are directly related to company information. Such open text fields are often subject to human error during entry. In addition, it can be frustrating for users to manually enter information that is already present in the business license that the customer has uploaded. Not only is manual entry of redundant information frustrating for users, it is also a problem for verifying and recording information when the entered information may have typos in the inputs. Such issues may cause increased load on the people responsible for validating and verifying the business licenses during the sign-up process. It also creates frustration on the part of users as often such mistakes may cause rejection of their registration applications and/or longer wait times to have validated, active business accounts.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 schematically illustrates a system-architecture diagram of an example service provider network that includes a business verification service within the service provider network for verifying and validating documents associated with establishing a business account with the service provider network.

FIG. 2 schematically illustrates an example flow for a signup process for the business account of FIG. 1.

FIG. 3 schematically illustrates a validation process for validating a business license image of FIG. 1.

FIG. 4 schematically illustrates an example flow 400 for the decision tree 318 of FIG. 3.

FIG. 5 schematically illustrates an arrangement for performing similarity validation within the business verification service of FIG. 1.

FIG. 6 schematically illustrates an arrangement for performing symbol recognition within the business verification service of FIG. 1.

FIG. 7 schematically illustrates an example of a business license.

FIG. 8 a flow diagram of an example method for automatically evaluating a document, e.g., a business license image, with a verification service, e.g., the business verification service, within a service provider network, e.g., the service provider network of FIG. 1.

FIG. 9 is a system and network diagram that shows an illustrative operating environment that includes a service provider network that can be configured to implement aspects of the functionality described herein.

FIG. 10 is a computing system diagram illustrating a configuration for a data center that can be utilized to implement aspects of the technologies disclosed herein.

FIG. 11 is a network services diagram that shows aspects of several services that can be provided by and utilized within a system, or a larger system of which the system is a part, which is configured to implement the various technologies disclosed herein.

FIG. 12 is a computer architecture diagram showing an illustrative computer hardware architecture for implementing a computing device that can be utilized to implement aspects of the various technologies presented herein.

### DETAILED DESCRIPTION

This disclosure describes, at least in part, techniques and architecture that provide an image extracting, processing, validating and publishing service that may utilize images of documents scanned and uploaded by a user. In particular, the service may scan a document image that has been uploaded by a user, resulting in an electronic document, and extract feature vectors from the electronic document. A validation using the feature vectors and one or more machine learning models may be conducted to check if the document is a valid document with respect to a purported document type. Information from the document may be published directly into an online template used for providing user and company information if the document is validated. Alternatively, the user may be notified if the uploaded image is invalid.

In configurations, a verification service is provided within a service provider network. In configurations, the verification service uses one or more machine learning models and optical character recognition (OCR) to validate business documents, e.g., business licenses, during a business account sign-up process and prepopulate a sign-up template with information from the business document.

At a high level, in configurations, in order to validate an uploaded business document image, e.g., a business license image, as authentic, the submitted image may be pre-processed to remove background features, distortions, etc. During the pre-processing, the image may be normalized and sharpened such that each image is adjusted to the same size. The processed image may then be extracted for characters and symbols and the data matched against a government database to confirm validity. Lastly, the extracted information may be populated into a template, e.g., an online account sign-up form for obtaining a business account. All these operations may occur in the background and within seconds (or less).

For example, during a business account sign-up process for the service provider network, a user may upload an image of a business document. If the business document is a business license, then the user may scan an image of the business license and upload it to the verification service provided within the service provider network. The verification service may then extract feature vectors from the business license and utilize various techniques to conduct a validation process to check if the scanned image is a valid business license.

In configurations, the verification service may utilize a first machine learning model to extract the feature vectors and perform a similarity validation. The machine learning model may compare the uploaded business license image feature vectors against feature vectors of multiple business licenses that have been used to train the first machine learning model.

In configurations, a second machine learning model may be utilized for symbol recognition within the business license in order to identify one or more symbols within the business license. For example, in configurations, the symbol recognition may search for a national emblem and a quick response (QR) code.

Additionally, in configurations, an optical character recognition (OCR) validation process may be utilized to extract text from the business license as another validation operation. If the business license is validated, the extracted text may be used to publish relevant company information within a template related to opening a business account at the service provider network.

In configurations, an example signup flow for the business account at the service provider network may include collecting user credentials during a first operation. Such user credentials may include, for example, an e-mail address, a user name, and a password. At a second operation of the signup flow, the image of the business license may be uploaded before company information is manually input by the user. The company information may include, for example, a company name, a company address, a company phone number, etc. During the second operation, the user may agree to terms of use for the business account at the service provider network and may also confirm tax information has been properly established with a local entity.

In some geographical regions, during a third operation, Information Security Administrator information may be collected. Examples of such information may include a name, an address, a phone number, and an identification number. During a fourth operation within the proposed signup flow, the identity of the user may be verified which may include the user's name, the user's address, the user's phone number, etc. Such identity may be verified via a text or a phone call. During a fifth operation, a support plan, e.g., a type of plan related to services desired from the service provider network, may be selected for the business account within the service provider network.

In configurations, if the scanned business license image is validated, then the business account may be approved. With the above sign-up process, approval may occur within a matter of seconds. However, if issues arise with respect to the validity of the business license but it appears that the business license may be valid, then the user may be informed that a manual review of the image of the business license needs to be performed. Issues that can lead to such a situation include an improperly scanned business license image, e.g., only a portion of the business license is included in the scanned image, artifacts on the business license image, e.g., water marks, scuffs, other stains, etc. The manual review may end up taking a day or two and thus, the user may be informed that they can upload a new scanned image of the business license if they would like in order to try the automated validation process again.

In configurations, the evaluation of the scanned image of the business license may lead to the failure of business license validation, e.g., the business license is determined to be invalid. Examples that might lead to such a failure include, for example, uploading an incorrect document, uploading a fake document, etc. In such situations, the user may be instructed to upload a new scanned image of a business license. This process can also only take a matter of seconds.

More particularly, when the user uploads an image of the business license, a first operation may be to process and enrich the image through pre-processing of the image. In configurations, the raw image uploaded by the user may be used for verification without any pre-processing. The pre-processing may be used to sharpen the image, which may improve the performance of subsequent verification operations. During the pre-processing operation, a check may be performed to ensure the image is of a sufficient/threshold quality and thus, blurry or low-quality images may be rejected. The image may also be enriched by correcting color and sharpness. A minimum and maximum threshold may be used to exclude low quality images, which helps avoid latency issues with respect to the verification process. As an example, a minimum threshold may be about 10 kilobytes (KB) and a maximum threshold may be about 10 megabytes (MB).

In configurations, the uploaded images may be enhanced or reduced to a standard size. This helps ensure consistency in the subsequent verification steps and helps facilitate maximum ability of the subsequent extraction and validation models to function properly. Example image formats include PDF, JPG, PNG image formats. Other image formats may also be supported in configurations.

In configurations, after pre-processing of an uploaded business license image, a first machine learning model may extract feature vectors from the uploaded business license image and compare the uploaded business license image feature vectors against templates of valid business licenses for a similarity evaluation between the uploaded business license and the templates of valid business licenses. In configurations, the first machine learning model may be configured as a Siamese neural network that may be used to generate a cosine similarity. This may facilitate elimination copies of fake business licenses or irrelevant business license images that do not match the standard business license templates. A Siamese neural network (sometimes referred to as a twin neural network) is an artificial neural network that uses the same weights while working in tandem on two different input vectors to compute comparable output vectors. Often one of the output vectors is precomputed, thus forming a baseline against which the other output vector is compared. This is similar to comparing fingerprints but may be described more technically as a distance function for locality-sensitive hashing. Cosine similarity is a measure of similarity between two sequences of numbers. For defining the cosine similarity, the sequences are viewed as vectors in an inner product space, and the cosine similarity is defined as the cosine of the angle between them. More particularity, the cosine similarity is defined as the dot product of the vectors divided by the product of their lengths. The cosine similarity does not depend on the magnitudes of the vectors, but only on their angle. The cosine similarity always belongs to the interval [−1,1], [−1,1]. For example, two proportional vectors have a cosine similarity of 1, two orthogonal vectors have a similarity of 0, and two opposite vectors have a similarity of −1.

In configurations, a templates group comprising numerous, e.g., hundreds, of business license templates may be used by the first machine learning model. This allows for inclusion of most, if not all, possible business license versions designed. This also facilitates comparison of numerous possible business license image quality varieties based upon how the uploaded business license image was created by the user. The feature embeddings of the two images for comparison (uploaded image and template) are extracted through a deep neural network, e.g., a ResNet, to provide extracted features that are compared. A ResNet (residual neural network) is an artificial neural network (ANN). It is a gateless or open-gated variant of the HighwayNet, the first working very deep feedforward neural network with hundreds of layers, much deeper than previous neural networks. Skip connections or shortcuts are used to jump over some layers (HighwayNet may also learn the skip weights themselves through an additional weight matrix for their gates). Typical ResNet models are implemented with double- or triple-layer skips that contain nonlinearities (ReLU) and batch normalization in between. Models with several parallel skips are referred to as DenseNets.

In configurations, the first machine learning model compares the extracted features from the business license image and the business license templates. Based on the comparison, the first machine learning model calculates a cosine similarity of the extracted features from the comparison to represent the similarity of the images (uploaded image and template). When the neural network is trained, cosine embedding loss may be used as the loss function. The goal of the neural network training is to make any business license/business license pair have a large similarity score and any business license/non-business license pair have a small similarity score. Each uploaded image may be compared with multiple (even all) business license templates of the templates group and a mean of the similarity scores may be calculated for an overall similarity score.

In configurations, after the similarity evaluation, a symbol recognition evaluation may be performed. The symbol recognition evaluation searches for key features of a valid business license that may include, for example, a national emblem and a quick response (QR) code. A second machine learning model may be used for the symbol recognition evaluation. In configurations, the second machine learning model is a single neural network configured to perform the object detection as a single regression task. The single neural network directly obtains bounding boxes and a probability of the classified object contained in an image. This method first divides the image into several grids of the same size. When the center of an object falls within a grid, the grid will output a classification probability and bounding box position of the object.

In configurations, the single neural network may comprise three parts. A first part may extract image feature representations through several convolutional layers and shortcut connections. A second part may be a structure of a feature pyramid network. Feature pyramids are a basic component in recognition systems for detecting objects at different scales. The feature maps of different scales at different stages in the deep neural network are combined by upsampling and lateral connections. The resulting multi-scale feature maps contain features extracted at different stages of the network. These feature maps have different expression capabilities for objects of different sizes, and the feature pyramid network may improve the detection accuracy of small objects. The third section may output whether there is a target in each grid, as well as the position and classification of the object. Finally, through post-processing, the national emblem and QR code in the image are obtained.

In configurations, after the symbol recognition evaluation, an optical character recognition (OCR) validation process may be performed to validate the business license image and thereby the business. OCR extracts text from the business license image and records relevant company information such as name, address, registration, etc. Once the data is retrieved, the data may be compared with a database, e.g., a government database, to make sure the company name and credit code exactly match as extracted from the business license image and the business is a legitimate business.

In configurations, to validate an uploaded business license image, a decision tree may be used that evaluates the results of the similarity evaluation, the symbol recognition evaluation and the OCR validation process. For example, if a similarity score provided by the similarity evaluation is above a predetermined threshold, e.g., 0.95, the symbol recognition score is above a predetermined threshold, e.g., greater than 0.6, and the OCR validation is positive, the business license image may be considered as an image of a valid business license. If all three conditions are not met then the business license image may be deemed to be one of a likely business license, a non-likely business license, or may be deemed to be a non-business license, i.e., a non-business license and/or invalid.

If the business license is verified/validated, e.g., the business is valid, company information extracted from the OCR process such as the company name, address, etc. may be preloaded, e.g., published, in the business account template associated with the business account sign-up process. In configurations, publishing may occur after the validation is completed and only validated business license information will be populated. The publishing may only pre-fill fields with company information on the business license. In configurations, the user may continue to have the ability to edit the information in the fields in the template. If the OCR process is unable to successfully extract information for any of the fields, the business license may fail validation and those fields may not be pre-loaded.

While the description has been primarily with respect to a business account at a service provider network and business licenses, the techniques and architecture may be equally applicable to more wide use cases and general applications. The techniques and architecture may be built as a standalone service (or as a service within a service provider network) that can identify a type of document and thus may be used to validate documents having a purported document type. In particular, the technology may differentiate and correctly identify whether an image is a passport or driver's license. The techniques and architecture may then perform related aesthetic, pattern and data validations to verify it is a valid document. The techniques and architecture may be applied to (and not limited to) personal identifications in various countries (citizen ID card, passport, driver license, etc.); business identifications in various countries (business licenses, tax documentations, Web operation documentations, legal person documentations); and other documentations or certifications (real estate certifications, automotive registrations, etc.).

Thus, the techniques and architecture described herein provide a business evaluation service within a service provider network. The business verification service automatically validates documents, e.g., business documents such business licenses, for establishing accounts within the service provider network. This reduces the need for manual review of the documents, which can take days and reduces the amount of time for validation to seconds or even less than a single second. This reduces needed manpower and also reduces errors, which reduces potential delays and needed computing power to correct the errors. As the techniques and architecture described herein determine the validity of electronic documents in an automated (or partially automated manner), fraudulent and/or inauthentic documents may be identified quickly and efficiently. Moreover, information from the validated documents may be used to prepopulate templates associated with establishing the account, thereby further reducing needed manpower and also further reducing errors, which further reduces potential delays and needed computing power to correct the errors.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

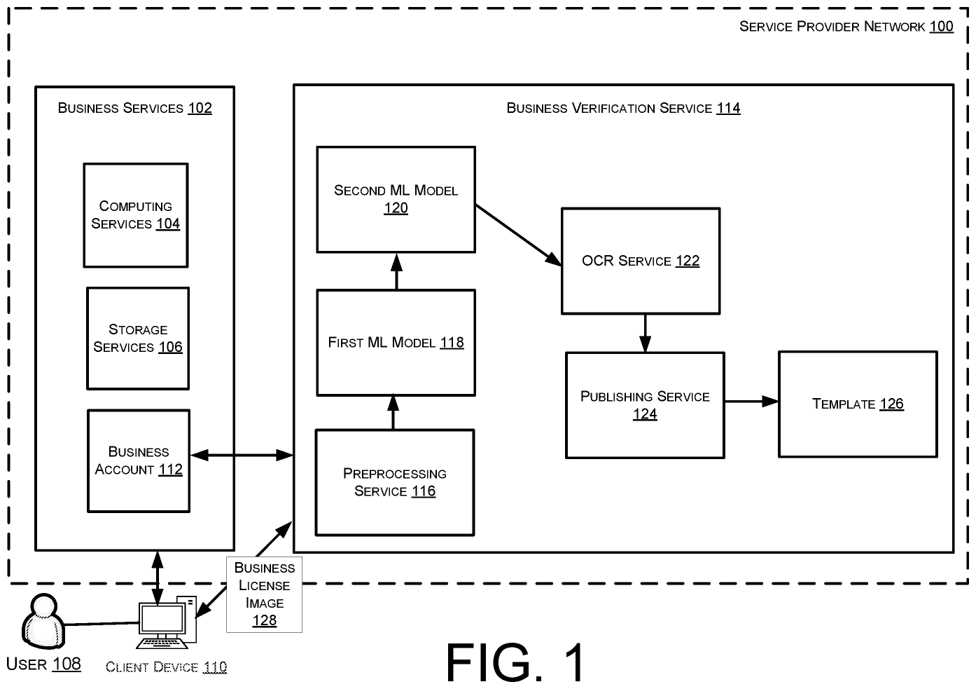

FIG. 1 illustrates a system-architecture diagram of an example service provider network 100. The service provider network 100 may comprise servers (not illustrated) that do not require end-user knowledge of the physical location and configuration of the system that delivers the services. Common expressions associated with the service provider network may include, for example, “on-demand computing,” “software as a service (Saas),” “cloud services,” “data centers,” and so forth. Services provided by the service provider network 100 may be distributed across one or more physical or virtual devices.

As may be seen in FIG. 1, the service provider network 100 includes business services 102 that are provided by the service provider network 100. The business services 102 may be provided to businesses or individuals. In configurations, examples of the business services 102 provided to users include, but are not limited to, computing services 104 and storage services 106. As is known, other types of services are generally provided by the business services 102 of the service provider network 100.

In configurations, a user 108 accesses the service provider network 100 using a client device 110. The user 108 may thus obtain business services 102 from the service provider network 100 using the client device 110. In order to access the business services 102, and other services of the service provider network 100, the user generally establishes a business account 112. In order to set up a business account 112, certain requirements may need to be met. For example, certain documentation may need to be provided based upon the locale of the user 108. For example, in certain geographical regions, if the user 108 represents a business, then the user 108 may need to provide a business license to the service provider network 100 in order to establish a business account 112.

As previously noted, manual review and validation of business licenses may be very timely, sometimes taking days to complete. Thus, in accordance with configurations, the service provider network 100 includes a business verification service 114. The business verification service includes a pre-processing service 116, a first machine learning (ML) model 118, a second ML model 120, an optical character recognition (OCR) service 122, a publishing service 124, and a template 126. The template 126 is generally in the form of an online signup form that may be displayed on a display of the user's client device 110.

In configurations, the user 108 may upload a business license image 128 via the client device 110 to the business verification service 114. As will be described further herein, the pre-processing service 116 pre-processes the business license image 128. The pre-processed business license image 128 may then be forwarded to the first ML model 118. Once the first ML model has completed its handling and evaluation of the business license image 128, the first ML model 118 may forward the business license image 128 to the second ML model 120, which may then forward the business license 128 to the OCR service 122. If the business license image 128 is validated, e.g., is an image of an actual business license, as will be discussed further herein, the publishing service may pre-populate, e.g., publish, company information from the business license image 128 to the template 126. In configurations, the first ML model 118, the second ML model 120, and the OCR service 122 evaluate the business license image 128 in parallel, e.g., at the same time.

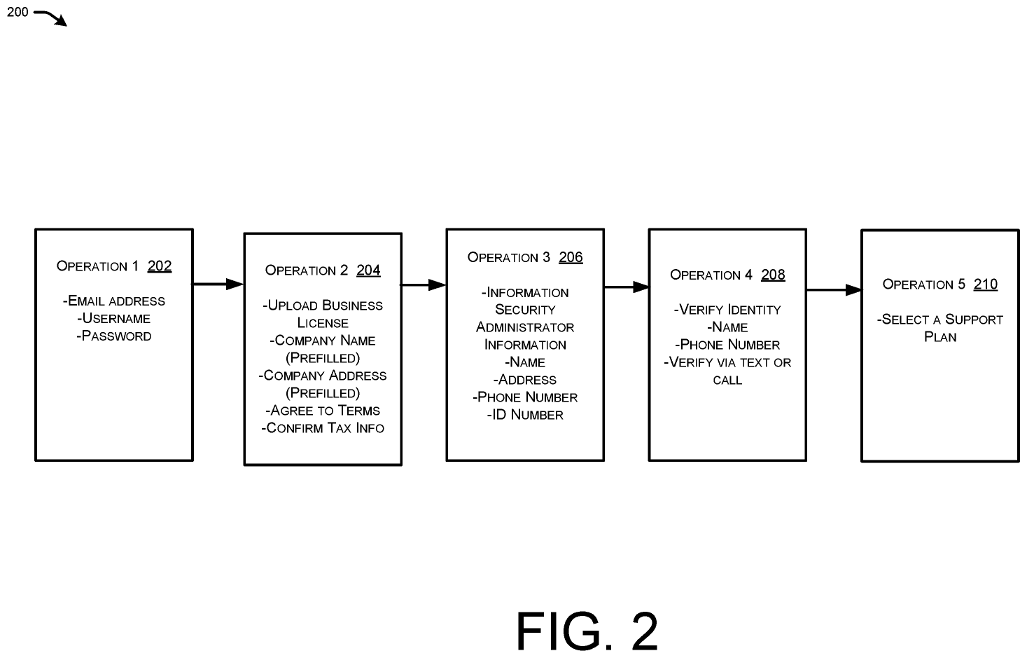

FIG. 2 schematically illustrates an example flow for a signup process 200 for the business account 112 of FIG. 1. In configurations, the example signup flow 200 for the business account 112 at the service provider network 100 may include collecting user credentials during a first operation 202. Such user credentials may include, for example, an e-mail address, a user name, and a password. At a second operation 204 of the signup flow 200, the image of the business license 128 may be uploaded before company information is manually input by the user 108. The company information may include, for example, a company name, a company address, a company phone number, etc. During the second operation 204, the user 108 may agree to terms of use for the business account 112 at the service provider network 100 and may also confirm tax information has been properly established with a local entity.

In some geographical regions, during a third operation 206, Information Security Administrator information may be collected. Examples of such Information Security Administrator information may include a name, an address, a phone number, and an identification number. During a fourth operation 208 within the example signup flow 200, the identity of the user 108 may be verified, which may include verifying the user's name, the user's address, the user's phone number, etc. Such user identity may be verified via a text or a phone call. During a fifth operation 210, a support plan, e.g., a type of plan related to services desired from the service provider network 100, may be selected for the business account within the service provider network.

In configurations, if the scanned business license image is validated, then the business account 112 may be approved. With the above sign-up process 200, approval may occur within a matter of seconds. However, if issues arise with respect to the validity of the business license image 128 but it appears that the business license may be valid, then the user 108 may be informed that a manual review of the image of the business license image 128 needs to be performed. Issues that can lead to such a situation include an improperly scanned business license image, e.g., only a portion of the business license is included in the scanned image, artifacts on the business license image, e.g., water marks, scuffs, other stains, etc. The manual review may end up taking a day or two and thus, the user 108 may be informed that they can upload a new scanned image of the business license if they would like in order to try the automated validation process again.

In configurations, the evaluation of the scanned image of the business license 128 may lead to the failure of business license image 128 validation, e.g., the business license is determined to be invalid. Examples that might lead to such a failure include, for example, uploading an incorrect document, uploading a fake document, etc. In such situations, the user may be instructed to upload a new scanned image of a business license. This process can also only take a matter of seconds.

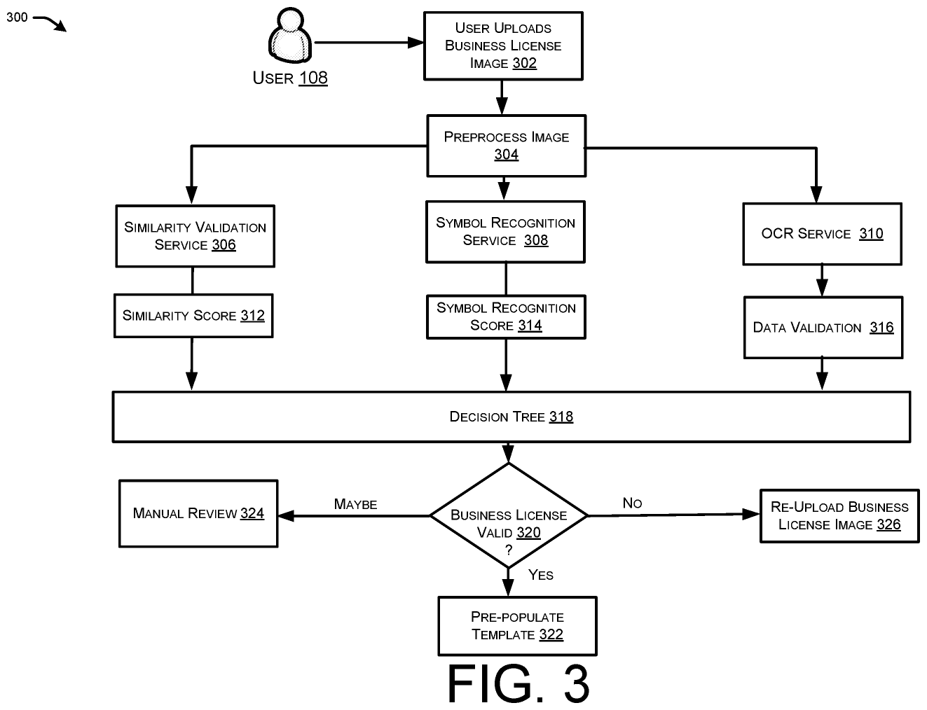

FIG. 3 schematically illustrates a validation process 300 for validating the business license image 128. The user 108 uploads the business license image 128 at 302. The business license image 128 may then be pre-processed at 304. The pre-processed image 128 may be provided to a similarity validation service that provides similarity validation at 306. The pre-processed image 128 may also be provided to a symbol recognition service that performs symbol recognition at 308. The pre-processed image 128 may also be provided to an OCR service 310, e.g., OCR service 122. In configurations, the similarity validation service comprises the first ML model 118 and the symbol recognition service comprises the second ML model 120.

In configurations, the similarity validation service provides a similarity score at 312. The symbol recognition service provides a symbol recognition score at 314. The OCR service provides a data validation, e.g., yes or no, valid or invalid, etc., at 316. The similarity score 312, the symbol recognition score 314 and the data validation 316 are provided to a decision tree 318. At 320, the decision tree provides output based on the similarity score 312, the symbol recognition score 314 and the data validation 316. At 320, it is determined if the business license is valid. If yes, then the template 126 may be pre-populated with company information at 322. If it is not clear, as will be discussed further herein, if the business license is valid, then a manual review may be performed of the image of the business license image at 324. If the business license is definitely not valid, then at 326 the user 108 may be instructed to re-upload a new business license image.

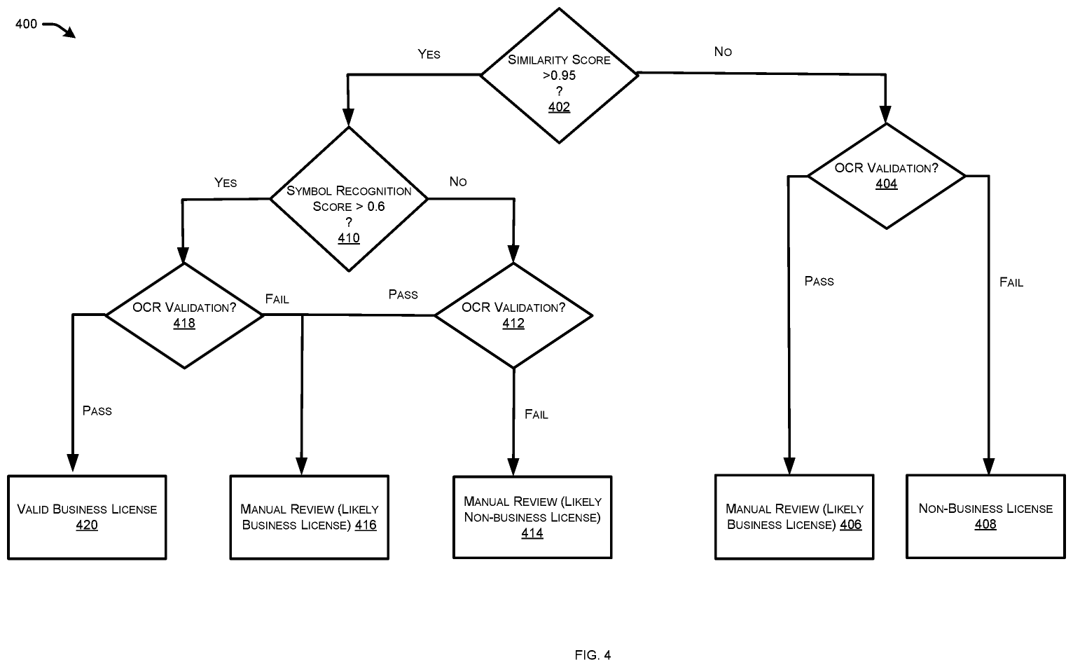

FIG. 4 schematically illustrates an example flow 400 for the decision tree 318 of FIG. 3. If at 402 the similarity score is less than a predetermined threshold, e.g., less than 0.95, then the decision tree may check the OCR validation at 404. If the OCR validation passes at 404, then the business license image 128 uploaded by the user 108 is likely a business license that requires manual review at 406. However, if the OCR validation fails at 404, then the business license image 128 is a non-business license.

If the similarity score is greater than 0.95 at 402, then the decision tree checks the symbol recognition score at 410 to see if it is greater than a predetermined threshold, e.g., 0.6. If the symbol recognition score at 410 is less than the predetermined threshold, e.g., less than 0.6, then the decision tree checks the OCR validation at 412. If it fails, then the decision tree 318 may indicate that a manual review is needed but that the business license image 128 is likely a non-business license. However, if the OCR validation passes at 412, then the decision tree 318 may indicate that a manual review is needed and that the business license image 128 is a likely business license at 416.

If at 410 the symbol recognition score is greater than 0.6, then the decision tree 318 may check the OCR validation at 418. If the OCR validation at 418 passes, then the business license image 128 is deemed a valid business license at 420. If the OCR validation at 418 fails, then the decision tree 318 may indicate that a manual review is needed and that the business license image 128 is a likely business license at 416.

More particularly, when the user 108 uploads an image of the business license, a first operation may be to process and enrich the image through pre-processing of the image. In configurations, the raw image uploaded by the user may be used for validation of the business license image 128 without any pre-processing. The pre-processing may be used to sharpen the image, which may improve the performance of subsequent validation operations. During the pre-processing operation, a check may be performed to ensure the image is of the right quality and thus, blurry or low-quality business license images 128 may be rejected. The business license image 128 may also be enriched by correcting color and sharpness. A minimum and maximum threshold may be used to exclude low quality images, which helps avoid latency issues with respect to the validation process. As an example, a minimum threshold may be about 10 kB and a maximum threshold may be about 10 MB.

In configurations, during the pre-processing operation, the uploaded images 128 may be enhanced or reduced to a standard size. This helps ensure consistency in the subsequent verification steps and helps facilitate maximum ability of the subsequent extraction and validation models to function properly. Example image formats include PDF, JPG, PNG image formats. Other image formats may also be supported in configurations.

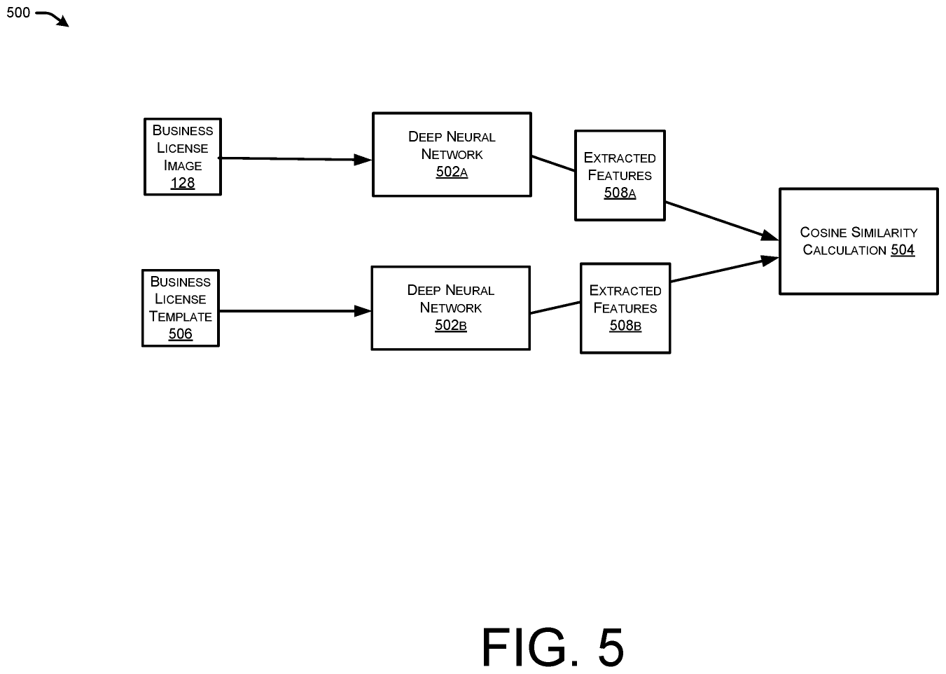

FIG. 5 schematically illustrates an arrangement 500 for performing similarity validation at the similarity validation service. The similarity validation service 500 includes a deep neural network 502A and a deep neural network 502B. The deep neural networks 502A, 502B provide extracted features 508A and 508B, respectively. In configurations, the deep neural networks 502a, 502b represent the first ML model 118. Extracted features 508A are based on the business license image 128 provided to the deep neural network 502A, while the extracted features 508B are the result of a business license template 506 being provided to the deep neural network 502B. The extracted features 508A, 508B are provided to a cosine similarity calculation module 504 that provides a similarity validation score based on the cosine similarity calculation.

Thus, in configurations, after pre-processing of an uploaded business license image 128, the deep neural networks 502a, 502b may extract feature vectors 508a from the uploaded business license image 128 and extracted feature vectors 508b from the business license template 506. The cosine similarity calculation 504 may compare the uploaded business license image feature vectors against the extracted feature of the valid business license template 506 for a similarity evaluation between the uploaded business license image 128 and the business license template 506.

In configurations, the deep neural networks 502a, 502b may be configured as a Siamese neural network that may be used to generate a cosine similarity. This may facilitate elimination copies of fake business licenses or irrelevant business license images that do not match the standard business license templates. A Siamese neural network (sometimes referred to as a twin neural network) is an artificial neural network that uses the same weights while working in tandem on two different input vectors to compute comparable output vectors. Often one of the output vectors, e.g., the output vector of business license template 506 via the deep neural network 502b, is precomputed, thus forming a baseline against which the other output vector is compared. This is similar to comparing fingerprints but may be described more technically as a distance function for locality-sensitive hashing. Cosine similarity is a measure of similarity between two sequences of numbers. For defining the cosine similarity, the sequences are viewed as vectors in an inner product space, and the cosine similarity is defined as the cosine of the angle between them. More particularity, the cosine similarity is defined as the dot product of the vectors divided by the product of their lengths. The cosine similarity does not depend on the magnitudes of the vectors, but only on their angle. The cosine similarity always belongs to the interval [−1,1], [−1,1]. For example, two proportional vectors have a cosine similarity of 1, two orthogonal vectors have a similarity of 0, and two opposite vectors have a similarity of −1.

In configurations, a templates group comprising numerous, e.g., hundreds, of business license templates 506 may be used by the deep neural network 502b. This allows for inclusion of most, if not all, possible business license versions designed. This also facilitates comparison of numerous possible business license image quality varieties based upon how the uploaded business license image 128 was created by the user 108. The feature embeddings of the two images for comparison (uploaded image and template) are extracted through a deep neural network, e.g., a ResNet, to provide extracted features that are compared. A ResNet (residual neural network) is an artificial neural network (ANN). The ResNet is a gateless or open-gated variant of the HighwayNet, the first working very deep feedforward neural network with hundreds of layers, much deeper than previous neural networks. Skip connections or shortcuts are used to jump over some layers (HighwayNet may also learn the skip weights themselves through an additional weight matrix for their gates). Typical ResNet models are implemented with double- or triple-layer skips that contain nonlinearities (ReLU) and batch normalization in between. Models with several parallel skips are referred to as DenseNets.

As previously noted, in configurations, the cosine similarity calculation 504 compares the extracted features 508a, 508b from the business license image 128 and the business template 506 to create the output. Based on the comparison, a cosine similarity of the extracted features 508a, 508b is calculated from the comparison to represent the similarity of the images (uploaded image and template). When the deep neural networks 502a, 502b are trained, cosine embedding loss may be used as the loss function. The goal of the neural network training is to make any valid business license/valid business license pair have a large similarity score and any valid business license/invalid business license pair have a small similarity score. Each uploaded business license image 128 may be compared with multiple (even all) business license templates 506 of the templates group and a mean of the similarity scores may be calculated for an overall similarity score.

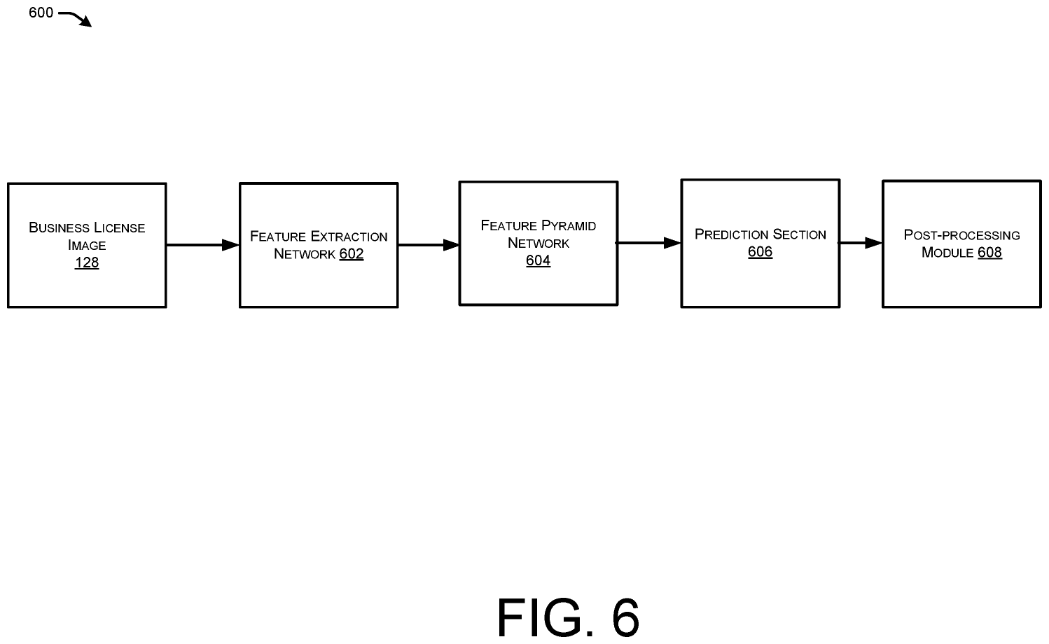

FIG. 6 schematically illustrates an example arrangement 600 for performing the symbol recognition evaluation. In configurations, the symbol recognition arrangement 600 represents the second ML learning model 120 and includes a feature extraction network 602 that extracts features from the uploaded business license image 128. The extracted features are provided to a feature pyramid network 604 that provides feature maps of different scales at different stages in the deep network that are combined by up-sampling and lateral connections. The resulting multi-scale feature maps are provided to a prediction section 606 that predicts the likelihood of an object being located, e.g., a symbol, within the business license image 128. Post-processing is performed by a post-processing module 608, which may detect whether the actual symbol is present within grids of the business license image 128. The post-processing module 608 may provide a symbol recognition score as to the likelihood of the presence and positioning of the desired objects, e.g., an emblem and a QR code in the business license image 128. In configurations, the feature extraction network 602, the feature pyramid network 604, the prediction section 606, and the post-processing module 608 make up the second ML model 120 of FIG. 1 in the business verification service 114.

Thus, in configurations, after the similarity evaluation, a symbol recognition evaluation may be performed by the example arrangement 600 on the business license image 128. The symbol recognition evaluation searches for key features of a valid business license in the business license image 128 that may include, for example, an official emblem and a quick response (QR) code. The example arrangement 600 may be used for the symbol recognition evaluation. In configurations, the example arrangement 600 is a single neural network configured to perform the object detection as a single regression task. The single neural network directly obtains bounding boxes and a probability of the classified object contained in an image. This method first divides the image into several grids of the same size. When the center of an object falls within a grid, the grid may output a classification probability and bounding box position of the object.

In configurations, feature extraction network 602 may extract image feature representations through several convolutional layers and shortcut connections. The feature pyramid network 604 is also included in the example arrangement 600. Feature pyramids are a basic component in recognition systems for detecting objects at different scales. The feature maps of different scales at different stages in the deep neural network are combined by upsampling and lateral connections. The resulting multi-scale feature maps contain features extracted at different stages of the network. These feature maps have different expression capabilities for objects of different sizes, and the feature pyramid network may improve the detection accuracy of small objects. The prediction section 606 of the example arrangement 600 may output whether there is a target in each grid, as well as the position and classification of the object, e.g., the emblem and the QR code. Finally, through post-processing, the national emblem and QR code in the image may be obtained.

In configurations, after the symbol recognition evaluation, an optical character recognition (OCR) validation process by OCR service 122, may be performed to validate the business license image 128 and thereby the business. OCR extracts text from the business license image 128 and records relevant company information such as name, address, registration, etc., as data. Once the data is retrieved, the data may be compared with a database, e.g., a government database, to make sure the company name and credit code exactly match as extracted from the business license image 128 and the corresponding business is a legitimate business.

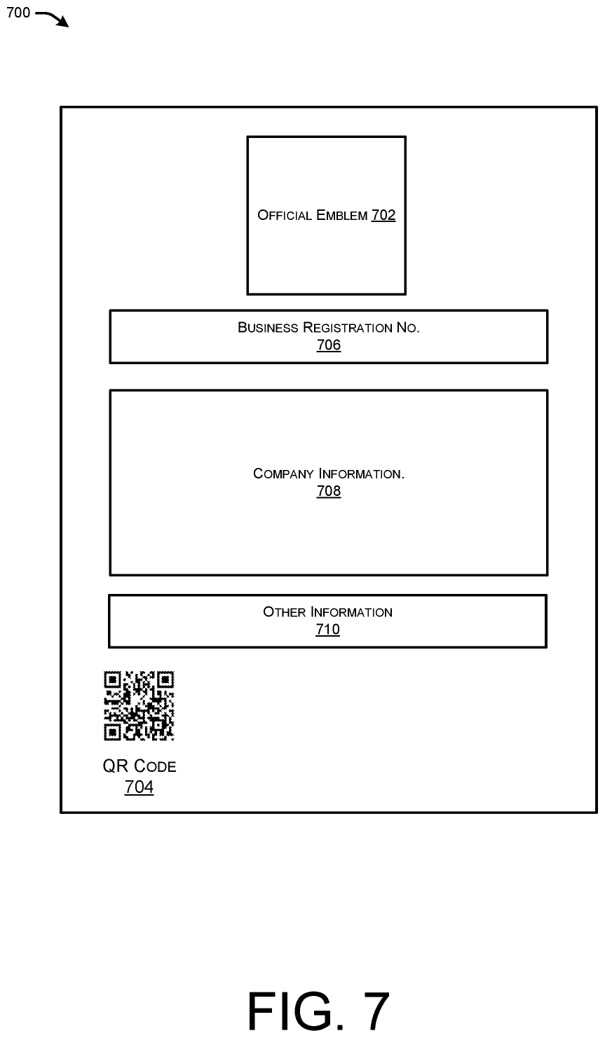

FIG. 7 schematically illustrates an example 700 of a business license 700. The business license includes an official emblem 702 and a QR code 704. Additional information may be included within the business license 700, for example, a business registration number 706 and company information 708. Other information 710, for example, a business scope, a business' intended activity, amount of registered capital, a founding date, an operating period, etc., may also be included on the business license 700. In particular, fields that may be extracted from the business license 710, include, for example, LicenseType, CompanyName, Company Type, RegistrationCode, SerialNumber, OwnerName, RegistrationCapital, PaidInCapital, BusinessScope, EstablishedTime, OperatingPeriod, ComposingForm, CreditCode, Address, etc.

If the business license in the business license image 128 is verified/validated, e.g., the business is valid, company information extracted from the OCR service 122 such as the company name, address, etc. may be preloaded, e.g., published by the publishing service 124, in the business account template 126 associated with the business account sign-up process 200. In configurations, publishing may occur after the validation of the business license image 128 is completed and only validated business license information may be populated. In configurations, the publishing service 124 may only pre-fill fields of the template 126 with the company information 708 from the business license image 128. In some configurations, the publishing may pre-fill fields with other information 710 and/or additional information, e.g., the business registration no. 706, from the business license image 128. In configurations, the user 108 may continue to have the ability to edit the information in the fields in the template 126. If the OCR service 122 is unable to successfully extract information for any of the fields, the business license image 128 may fail validation and those fields may not be pre-loaded in the template 128.

While the description has been primarily with respect to a business account 112 at a service provider network 100 and business licenses, the techniques and architecture may be equally applicable to more wide use cases and general applications. The techniques and architecture may be built as a standalone service (or as a service within the service provider network 100) that can identify a type of document and thus may be used to validate documents having a purported document type. In particular, the technology may differentiate and correctly identify whether an image is a passport or driver's license. The techniques and architecture may then perform related aesthetic, pattern and data validations to verify it is a valid document. The techniques and architecture may be applied to (and not limited to) personal identifications in various countries (citizen ID card, passport, driver license, etc.); business identifications in various countries (business licenses, tax documentations, Web operation documentations, legal person documentations); and other documentations or certifications (real estate certifications, automotive registrations, etc.).

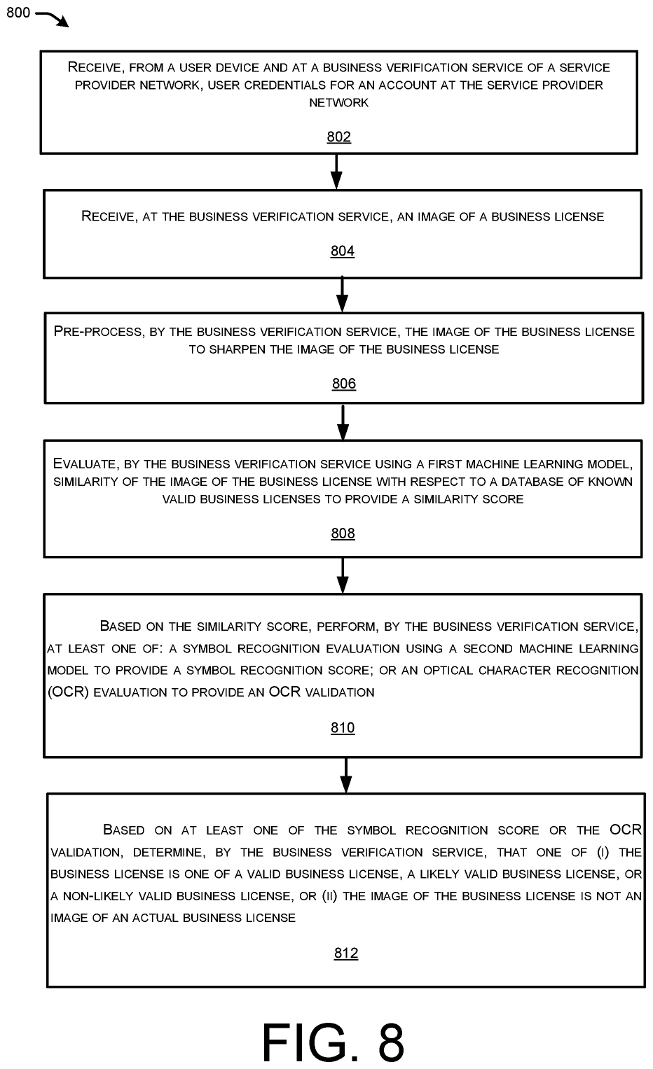

FIG. 8 illustrates a flow diagram of an example method 800 that illustrates aspects of the functions performed at least partly by the services as described in FIGS. 1-7. The logical operations described herein with respect to FIG. 8 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 8 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 8 illustrates a flow diagram of the example method 800 for automatically evaluating a document, e.g., a business license image 128, with a verification service, e.g., business verification service 114, within a service provider network, e.g., service provider network 100, for establishing an account with the service provider network.

At 802, a business verification service of a service provider network receives user credentials. For example, user credentials for an account 112 at the service provider network may be provided by the user 108. The user credentials may include, for example, an e-mail address, a user name, and a password.

At 804, the business verification service receives an image of a business license. For example, the user 108 may upload the business license image 128 via the client device 110 to the business verification service 114.

At 806, the business verification service pre-processes the image of the business license to sharpen the image of the business license. For example, the pre-processing service 116 pre-processes the business license image 128 to process and enrich the image. The pre-processing may be used to sharpen the image 128, which may improve the performance of subsequent validation operations. During the pre-processing operation, a check may be performed to ensure the image is of the right quality and thus, blurry or low-quality business license images 128 may be rejected. The business license image 128 may also be enriched by correcting color and sharpness.

At 808, the business verification service evaluates, using a first machine learning model, a similarity of the image of the business license with respect to a database of known valid business licenses to provide a similarity score. For example, after pre-processing of an uploaded business license image 128, the deep neural networks 502a, 502b may extract feature vectors 508a from the uploaded business license image 128 and extracted feature vectors 508b from the business license template 506. The cosine similarity calculation 504 may compare the uploaded business license image feature vectors against the extracted feature of the valid business license template 506 for a similarity evaluation between the uploaded business license image 128 and the business license template 506.

At 810, based on the similarity score, the business verification service performs at least one of a symbol recognition evaluation using a second machine model to provide a symbol recognition score or an optical character recognition (OCR) evaluation to provide an OCR validation. For example, if the similarity score exceeds a predetermined threshold, e.g., 0.95, a symbol recognition evaluation may be performed by the example arrangement 600 on the business license image 128. The symbol recognition evaluation searches for key features of a valid business license in the business license image 128 that may include, for example, an official emblem and a quick response (QR) code. The example arrangement 600 may be used for the symbol recognition evaluation. In configurations, the example arrangement 600 is a single neural network configured to perform the object detection as a single regression task. The single neural network directly obtains bounding boxes and a probability of the classified object contained in an image. This method first divides the image into several grids of the same size. When the center of an object falls within a grid, the grid may output a classification probability and bounding box position of the object. After the symbol recognition evaluation, an OCR validation may be performed. In configurations, if the similarity score is below a predetermined threshold, e.g., 0.95, the symbol recognition evaluation may not be performed and only the OCR validation may be performed.

At 812, based on at least one of the symbol recognition score or the OCR validation, the business verification service determines that one of (i) the business license is one of a valid business license, a likely valid business license, or a non-likely valid business license, or (ii) the image of the business license is not an image of an actual business license.

Accordingly, the techniques and architecture described herein provide a business evaluation service within a service provider network. The business verification service automatically validates documents, e.g., business documents such business licenses, for establishing accounts within the service provider network. This reduces the need for manual review of the documents, which can take days and reduces the amount of time for validation to seconds or even less than a single second. This reduces needed manpower and also reduces errors, which reduces potential delays and needed computing power to correct the errors. Information from the validated documents may be used to prepopulate templates associated with establishing the account, thereby further reducing needed manpower and also further reducing errors, which further reduces potential delays and needed computing power to correct the errors.

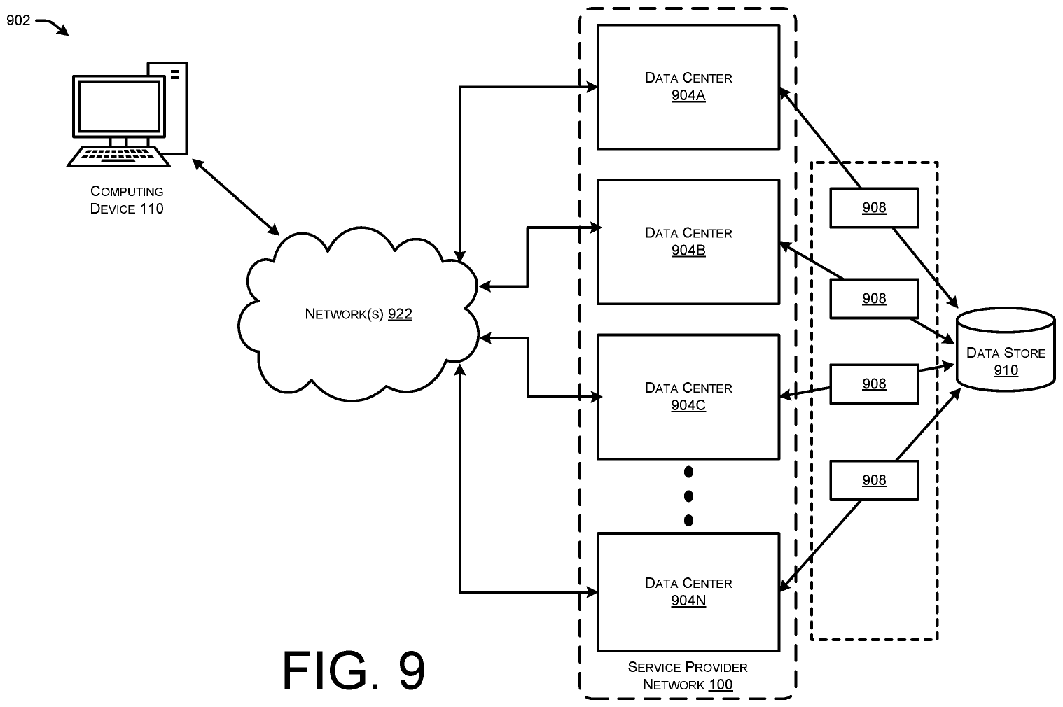

FIG. 9 is a system and network diagram that shows one illustrative operating environment 902 for the configurations disclosed herein that includes a service provider network 100 that can be configured to perform the techniques disclosed herein and which may be accessed by a computing device, e.g. client device 110. The service provider network 100 can provide computing resources, like VM instances and storage, on a permanent or an as-needed basis. Among other types of functionalities, the computing resources provided by the service provider network 100 may be utilized to implement the various services described above such as, for example, the test prediction service 102.

Each type of computing resource provided by the service provider network 100 can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The service provider network 100 can also be configured to provide other types of computing resources not mentioned specifically herein.

The computing resources provided by the service provider network 100 may be enabled in one embodiment by one or more data centers 904A-904N (which might be referred to herein singularly as “a data center 904” or in the plural as “the data centers 904”). The data centers 904 are facilities utilized to house and operate computer systems and associated components. The data centers 904 typically include redundant and backup power, communications, cooling, and security systems. The data centers 904 can also be located in geographically disparate locations. One illustrative embodiment for a data center 904 that can be utilized to implement the technologies disclosed herein will be described below with regard to FIG. 9.

The data centers 904 may be configured in different arrangements depending on the service provider network 100. For example, one or more data centers 904 may be included in or otherwise make-up an availability zone. Further, one or more availability zones may make-up or be included in a region. Thus, the service provider network 100 may comprise one or more availability zones, one or more regions, and so forth. The regions may be based on geographic areas, such as being located within a predetermined geographic perimeter.

Users of the service provider network 100 may access the computing resources provided by the service provider network 100 over any wired and/or wireless network(s) 922, which can be a wide area communication network (“WAN”), such as the Internet, an intranet or an Internet service provider (“ISP”) network or a combination of such networks. For example, and without limitation, a computing device, e.g., computing device 902, operated by a user of the service provider network 100 may be utilized to access the service provider network 100 by way of the network(s) 922. It should be appreciated that a local-area network (“LAN”), the Internet, or any other networking topology known in the art that connects the data centers 904 to remote customers and other users can be utilized. It should also be appreciated that combinations of such networks can also be utilized.

Each of the data centers 904 may include computing devices that include software, such as applications that receive and transmit data 908. For instance, the computing devices included in the data centers 904 may include software components which transmit, retrieve, receive, or otherwise provide or obtain the data 908 from a data store 910. For example, the data centers 904 may include or store the data store 910, which may include the data 908.

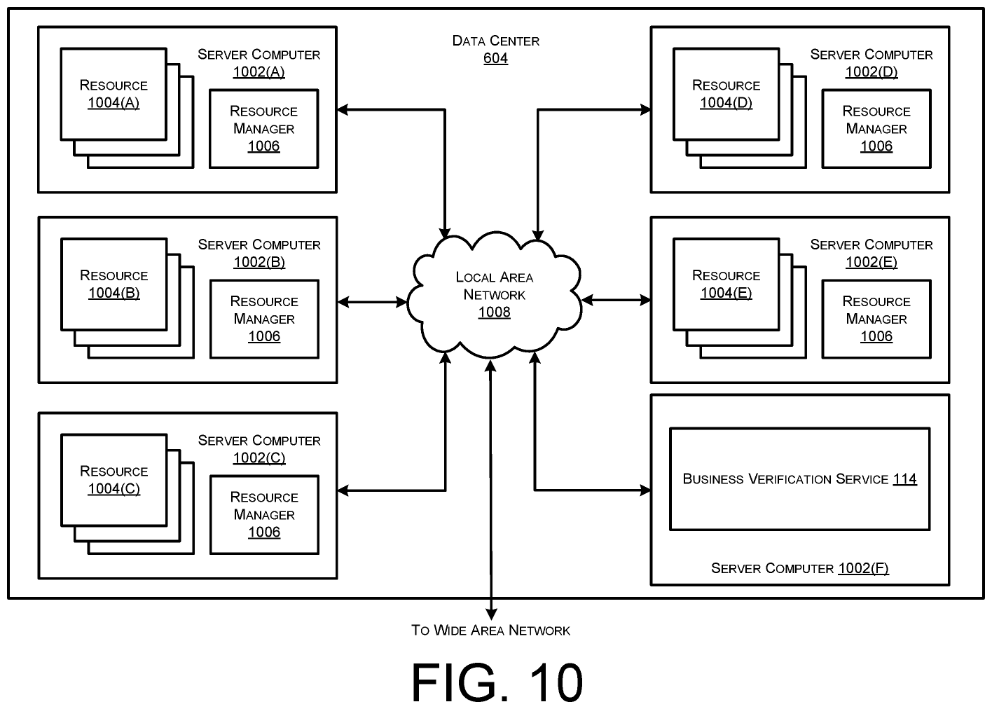

FIG. 10 is a computing system diagram that illustrates one configuration for a data center 1004 that implements aspects of the technologies disclosed herein. The example data center 1004 shown in FIG. 10 includes several server computers 1002A-1002F (which might be referred to herein singularly as “a server computer 1002” or in the plural as “the server computers 1002”) for providing computing resources 1004A-1004E.

The server computers 1002 can be standard tower, rack-mount, or blade server computers configured appropriately for providing the computing resources described herein (illustrated in FIG. 10 as the computing resources 1004A-1004E). As mentioned above, the computing resources provided by the service provider network 100 can be data processing resources such as VM instances or hardware computing systems, database clusters, computing clusters, storage clusters, data storage resources, database resources, networking resources, and others. Some of the servers 1002 can also be configured to execute a resource manager 1006 capable of instantiating and/or managing the computing resources. In the case of VM instances, for example, the resource manager 1006 can be a hypervisor or another type of program configured to enable the execution of multiple VM instances on a single server computer 1002. Server computers 1002 in the data center 1004 can also be configured to provide network services and other types of services.

The data center 1004 shown in FIG. 10 also includes a server computer 1002F that can execute some or all of the software components described above. For example, and without limitation, the server computer 1002F can be configured to execute components of the service provider network 100, including the business verification service 102, and/or the other software components described above. The server computer 1002F can also be configured to execute other components and/or to store data for providing some or all of the functionality described herein. In this regard, it should be appreciated that the services illustrated in FIG. 10 as executing on the server computer 1002F can execute on many other physical or virtual servers in the data centers 1004 in various embodiments.

In the example data center 1004 shown in FIG. 10, an appropriate LAN 1008 is also utilized to interconnect the server computers 1002A-1002F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between each of the data centers 1004A-1004N, between each of the server computers 1002A-1002F in each data center 1004, and, potentially, between computing resources in each of the server computers 1002. It should be appreciated that the configuration of the data center 1004 described with reference to FIG. 10 is merely illustrative and that other implementations can be utilized.

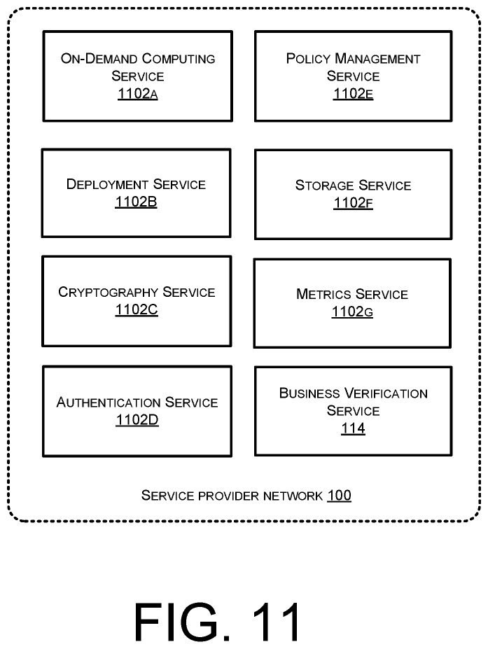

FIG. 11 is a system and network diagram that shows aspects of several network services that can be provided by and utilized within a service provider network 100 in one embodiment disclosed herein. In particular, and as discussed above, the service provider network 100 can provide a variety of network services to users within the service provider network 100, as well as customers, including, but not limited to, the test prediction service 102. The service provider network 100 can also provide other types of services including, but not limited to, an on-demand computing service 1102A, a deployment service 1102B, a cryptography service 1102C, a storage service 1102D, an authentication service 1102E, and/or a policy management service 1102G, some of which are described in greater detail below. Additionally, the service-provider network 100 can also provide other services, some of which are also described in greater detail below.

It should be appreciated that customers of the service provider network 100 can include organizations or individuals that utilize some or all of the services provided by the service provider network 100. As described herein, a customer or other user can communicate with the service provider network 100 through a network, such as the network 922 shown in FIG. 9. Communications from a user computing device, such as the computing device 902 shown in FIG. 9, to the service provider network 100 can cause the services provided by the service provider network 100 to operate in accordance with the described configurations or variations thereof.

It is noted that not all embodiments described include the services described with reference to FIG. 11 and that additional services can be provided in addition to or as an alternative to services explicitly described. Each of the services shown in FIG. 11 can also expose network services interfaces that enable a caller to submit appropriately configured API calls to the various services through web service requests. In addition, each of the services can include service interfaces that enable the services to access each other (e.g., to enable a virtual computer system provided by the on-demand computing service 1102A to store data in or retrieve data from a storage service). Additional details regarding some of the services shown in FIG. 11 will now be provided.

As discussed above, the on-demand computing service 1102A (can be a collection of computing resources configured to instantiate VM instances and to provide other types of computing resources on demand. For example, a customer or other user of the service provider network 100 can interact with the on-demand computing service 1102A (via appropriately configured and authenticated network services API calls) to provision and operate VM instances that are instantiated on physical computing devices hosted and operated by the service provider network 100.

The VM instances can be used for various purposes, such as to operate as servers supporting a web site, to operate business applications or, generally, to serve as computing resources for the customer. Other applications for the VM instances can be to support database applications such as those described herein, electronic commerce applications, business applications and/or other applications. Although the on-demand computing service 1102A is shown in FIG. 11, any other computer system or computer system service can be utilized in the service provider network 100, such as a computer system or computer system service that does not employ virtualization and instead provisions computing resources on dedicated or shared computers/servers and/or other physical devices.

The service provider network 100 can also include a cryptography service 1102C. The cryptography service 1102C can utilize storage services of the service provider network 100 to store encryption keys in encrypted form, whereby the keys are usable to decrypt customer keys accessible only to particular devices of the cryptography service 1102C. The cryptography service 1102C can also provide other types of functionality not specifically mentioned herein.

As illustrated in FIG. 11, the service provider network 100, in various embodiments, also includes an authentication service 1102D and a policy management service 1102E. The authentication service 1102D, in one example, is a computer system (i.e., collection of computing resources) configured to perform operations involved in authentication of users. For instance, one of the services 1102 shown in FIG. 11 can provide information from a user to the authentication service 1102D to receive information in return that indicates whether or not the requests submitted by the user are authentic.

The policy management service 1102E, in one example, is a network service configured to manage policies on behalf of customers or internal users of the service provider network 100. The policy management service 1102E can include an interface that enables customers to submit requests related to the management of policy. Such requests can, for instance, be requests to add, delete, change or otherwise modify policy for a customer, service, or system, or for other administrative actions, such as providing an inventory of existing policies and the like.

The service provider network 100 can additionally maintain other services 1102 based, at least in part, on the needs of its customers. For instance, the service provider network 100 can maintain a deployment service 1102B for deploying program code and/or a data warehouse service in some embodiments. Other services can include object-level archival data storage services, database services, and services that manage, monitor, interact with, or support other services. The service provider network 100 can also be configured with other services not specifically mentioned herein in other embodiments.

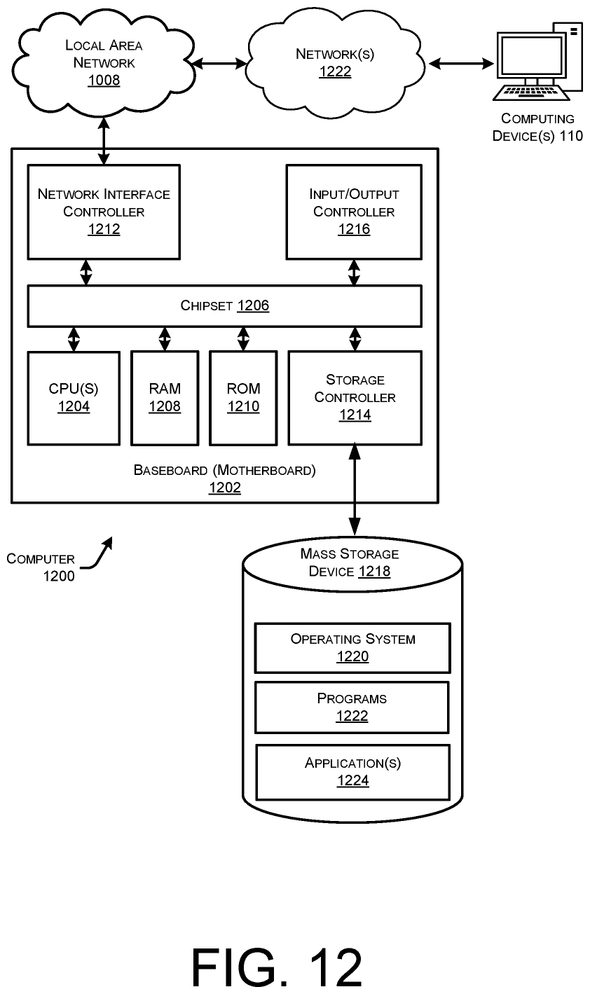

FIG. 12 shows an example computer architecture for a computer 1200 capable of executing program components for implementing the functionality described above. The computer architecture shown in FIG. 12 illustrates a server computer, workstation, desktop computer, laptop, tablet, network appliance, e-reader, smartphone, or other computing device, and can be utilized to execute any of the software components presented herein.

The computer 1200 includes a baseboard 1202, or “motherboard,” which is a printed circuit board to which a multitude of components or devices can be connected by way of a system bus or other electrical communication paths. In one illustrative configuration, one or more central processing units (“CPUs”) 1204 operate in conjunction with a chipset 1206. The CPUs 1204 can be standard programmable processors that perform arithmetic and logical operations necessary for the operation of the computer 1200.

The CPUs 1204 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1206 provides an interface between the CPUs 1204 and the remainder of the components and devices on the baseboard 1202. The chipset 1206 can provide an interface to a RAM 1208, used as the main memory in the computer 1200. The chipset 1206 can further provide an interface to a computer-readable storage medium such as a read-only memory (“ROM”) 1210 or non-volatile RAM (“NVRAM”) for storing basic routines that help to startup the computer 1200 and to transfer information between the various components and devices. The ROM 1210 or NVRAM can also store other software components necessary for the operation of the computer 1200 in accordance with the configurations described herein.

The computer 1200 can operate in a networked environment using logical connections to remote computing devices 1202 and computer systems through a network, such as the network 1208. The chipset 1206 can include functionality for providing network connectivity through a Network Interface Controller (NIC) 1212, such as a gigabit Ethernet adapter. The NIC 1212 is capable of connecting the computer 1200 to other computing devices 602 over the network 1008 (or 622). It should be appreciated that multiple NICs 1212 can be present in the computer 1200, connecting the computer to other types of networks and remote computer systems.

The computer 1200 can be connected to a mass storage device 1218 that provides non-volatile storage for the computer. The mass storage device 1218 can store an operating system 1220, programs 1222 (e.g., agents, etc.), data, and/or applications(s) 1224, which have been described in greater detail herein. The mass storage device 1218 can be connected to the computer 1200 through a storage controller 1214 connected to the chipset 1206. The mass storage device 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1200 can store data on the mass storage device 1218 by transforming the physical state of the physical storage units to reflect the information being stored. The specific transformation of physical states can depend on various factors, in different embodiments of this description. Examples of such factors can include, but are not limited to, the technology used to implement the physical storage units, whether the mass storage device 1218 is characterized as primary or secondary storage, and the like.

For example, the computer 1200 can store information to the mass storage device 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1200 can further read information from the mass storage device 1218 by detecting the physical states or characteristics of one or more particular locations within the physical storage units.

In addition to the mass storage device 1218 described above, the computer 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1200. In some examples, the operations performed by the service provider network 100, and or any components included therein, may be supported by one or more devices similar to computer 1200. Stated otherwise, some or all of the operations performed by the service provider network 100, and or any components included therein, may be performed by one or more computer devices 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the mass storage device 1218 can store an operating system 1220 utilized to control the operation of the computer 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The mass storage device 1218 can store other system or application programs and data utilized by the computer 1200.

In one embodiment, the mass storage device 1218 or other computer-readable storage media is encoded with computer-executable instructions which, when loaded into the computer 1200, transform the computer from a general-purpose computing system into a special-purpose computer capable of implementing the embodiments described herein. These computer-executable instructions transform the computer 1200 by specifying how the CPUs 1204 transition between states, as described above. According to one embodiment, the computer 1200 has access to computer-readable storage media storing computer-executable instructions which, when executed by the computer 1200, perform the various processes described above with regard to FIGS. 1-12. The computer 1200 can also include computer-readable storage media having instructions stored thereupon for performing any of the other computer-implemented operations described herein.

The computer 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can provide output to a display, such as a computer monitor, a flat-panel display, a digital projector, a printer, or other type of output device. It will be appreciated that the computer 1200 might not include all of the components shown in FIG. 12, can include other components that are not explicitly shown in FIG. 12, or might utilize an architecture completely different than that shown in FIG. 12.

The computer 1200 may transmit, receive, retrieve, or otherwise provide and/or obtain data and/or results to and/or from the service provider network 100. The computer 1200 may store the data on the operating system 1220, and/or the programs 1222 that are stored in the mass storage device 1218 to update or otherwise modify the operating system 1220 and/or the programs 1222.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving, from a user device and at a business verification service of a service provider network, user credentials for an account at the service provider network;
receiving, at the business verification service, an electronic image of a business license;
pre-processing, by the business verification service, the electronic image of the business license to sharpen the electronic image of the business license;
evaluating, by the business verification service using a first machine learning model, similarity of the electronic image of the business license with respect to a database of known valid business licenses to generate a similarity score;
based on the similarity score, performing, by the business verification service, at least one of:
a symbol recognition evaluation using a second machine learning model to generate a symbol recognition score; or
an optical character recognition (OCR) evaluation to generate an OCR validation; and
based on at least one of the symbol recognition score or the OCR validation, determining, by the business verification service, that (i) the business license is one of a valid business license, a likely valid business license, or a non-likely valid business license, or that (ii) the electronic image of the business license does not correspond to an actual business license.

2. The computer-implemented method of claim 1, further comprising:
determining that the similarity score meets or exceeds a first threshold value;
performing, based on the similarity score meeting or exceeding the first threshold value, the symbol recognition evaluation using the second machine learning model;
determining that the symbol recognition score meets or exceeds a second threshold value;
performing, based on the symbol recognition score meeting or exceeding the second threshold value, the OCR evaluation;
determining that the OCR validation meets or exceeds a third threshold value; and
determining, based on the OCR validation meeting or exceeding the third threshold value, that the business license is the valid business license.

3. The computer-implemented method of claim 1, further comprising:
determining that the similarity score meets or exceeds a first threshold value;
performing, based on the similarity score meeting or exceeding the first threshold value, the symbol recognition evaluation using the second machine learning model;
performing the OCR evaluation;
one of:
based on a first determination that the symbol recognition score is less than a second threshold value and that the OCR validation meets or exceeds a third threshold value, determining that the business license is the likely valid business license; or
based on a second determination that the symbol recognition score is less than the second threshold value and that the OCR validation is less than the third threshold value, determining that the business license is the non-likely valid business license; and
transmitting, to the user device, an indication that a manual review of the electronic image of the business license is recommended.

4. The computer-implemented method of claim 1, further comprising:
determining that the similarity score is less than a first threshold value;
performing, based on the similarity score being less than the first threshold value, the OCR evaluation;
determining that the OCR validation is less than a second threshold value;
determining, based on the OCR validation being less than the second threshold value, that the business license does not correspond to the actual business license; and
transmitting, to the user device, an indication that the electronic image of the business license does not correspond to the actual business license.

5. The computer-implemented method of claim 1, further comprising:
determining that the similarity score is less than a first threshold value;
performing, based on the similarity score being less than the first threshold value, the OCR evaluation;
determining that the OCR validation meets or exceeds a second threshold value;
determining, based on the OCR validation meeting or exceeding the second threshold value, that the business license is the likely valid business license; and
transmitting, to the user device, an indication that a manual review of the electronic image of the business license is recommended.

6. A method comprising:
receiving, at a verification service of a service provider network, an image of a document, wherein the document has a purported document type;
evaluating, by the verification service using a first machine learning model, similarity of the image of the document with respect to a database of known valid documents to determine a similarity score, wherein the known valid documents are with respect to the purported document type;
based at least in part on the similarity score, performing, by the verification service, at least one of (i) a symbol recognition evaluation using a second machine learning model to determine a symbol recognition score or (ii) an optical character recognition (OCR) evaluation to determine an OCR validation; and
based at least in part on at least one of the symbol recognition score or the OCR validation, determining, by the verification service, a status of the document with respect to the purported document type.

7. The method of claim 6, further comprising:
determining that the similarity score meets or exceeds a first threshold;
performing the symbol recognition evaluation using the second machine learning model;
determining that the symbol recognition score meets or exceeds a second threshold;
performing the OCR evaluation;
determining that the OCR validation meets or exceeds a third threshold; and
determining that the status of the document is valid with respect to the purported document type.

8. The method of claim 7, wherein the document relates to an account at the service provider network and further comprising:
based at least in part on the status of the document being valid with respect to the purported document type, automatically populating a template for the account with information from the document.

9. The method of claim 8, wherein the document is a business license.

10. The method of claim 6, further comprising:
determining that the similarity score meets or exceeds a first threshold;
performing the symbol recognition evaluation using the second machine learning model;
performing the OCR evaluation;
one of:
based at least in part on a first determination that the symbol recognition score is below a second threshold and that the OCR validation meets or exceeds a third threshold, determining that the status of the document is likely valid with respect to the purported document type; or
based at least in part on a second determination that the symbol recognition score is below a second threshold and that the OCR validation is below a third threshold, determining that the status of the document is likely non-valid with respect to the purported document type; and
informing a user that a manual review of the image of the document is recommended.

11. The method of claim 6, further comprising:
determining that the similarity score is below a first threshold;
performing the OCR evaluation;
determining that the OCR validation is below a second threshold;
determining that the status of the document is non-valid with respect to the purported document type; and
informing a user that the image of the document does not correspond to a valid document with respect to the purported document type.

12. The method of claim 6, further comprising:
determining that the similarity score is below a first threshold;
performing the OCR evaluation;
determining that the OCR validation meets or exceeds a second threshold;
determining that the status of the document is likely valid with respect to the purported document type; and
informing a user that a manual review of the image of the document is recommended.

13. The method of claim 6, wherein the purported document type comprises one of a passport, a driver's license, an identification card, or a tax document.

14. One or more computer-readable media storing computer-executable instructions that, when executed, cause one or more processors to perform operations comprising:
receiving, at a verification service of a service provider network, an image of a document, wherein the document has a purported document type;
evaluating, by the verification service using a first machine learning model, similarity of the image of the document with respect to a database of known valid documents to determine a similarity score, wherein the known valid documents are with respect to the purported document type;
based at least in part on the similarity score, performing, by the verification service, at least one of (i) a symbol recognition evaluation using a second machine learning model to determine a symbol recognition score or (ii) an optical character recognition (OCR) evaluation to determine an OCR validation; and
based at least in part on at least one of the symbol recognition score or the OCR validation, determining, by the verification service, a status of the document with respect to the purported document type.

15. The one or more computer-readable media of claim 14, wherein the operations further comprise:
determining that the similarity score meets or exceeds a first threshold;
performing the symbol recognition evaluation using the second machine learning model;
determining that the symbol recognition score meets or exceeds a second threshold;
performing the OCR evaluation;
determining that the OCR validation meets or exceeds a third threshold; and
determining that the status of the document is valid with respect to the purported document type.

16. The one or more computer-readable media of claim 14, wherein the document is a business license, wherein the business license relates to an account at the service provider network, and wherein the operations further comprise:
based at least in part on the status of the document being valid with respect to the purported document type, automatically populating a template for the account with information from the document.

17. The one or more computer-readable media of claim 14, wherein the operations further comprise:
determining that the similarity score meets or exceeds a first threshold;
performing the symbol recognition evaluation using the second machine learning model;
performing the OCR evaluation;
one of:
based at least in part on a first determination that the symbol recognition score is below a second threshold and that the OCR validation meets or exceeds a third threshold, determining that the status of the document is likely valid with respect to the purported document type; or
based at least in part on a second determination that the symbol recognition score is below a second threshold and that the OCR validation is below a third threshold, determining that the status of the document is likely non-valid with respect to the purported document type; and
informing a user that a manual review of the image of the document is recommended.

18. The one or more computer-readable media of claim 14, wherein the operations further comprise:
determining that the similarity score is below a first threshold;
performing the OCR evaluation;
determining that the OCR validation is below a second threshold;
determining that the status of the document is non-valid with respect to the purported document type; and
informing a user that the image of the document does not correspond to a valid document with respect to the purported document type.

19. The one or more computer-readable media of claim 14, wherein the operations further comprise:
determining that the similarity score is below a first threshold;
performing the OCR evaluation;
determining that the OCR validation meets or exceeds a second threshold;
determining that the status of the document is likely valid with respect to the purported document type; and
informing a user that a manual review of the image of the document is recommended.

20. The one or more computer-readable media of claim 14, wherein the purported document type comprises one of a passport, a driver's license, an identification card, or a tax document.
